(19) United States
(12) Patent Application Publication
(10) Pub. No.: US 2008/0250407 A1
(43) Pub. Date: Oct. 9, 2008

(54) Network group name for virtual machines

(75) Inventors: Rajesh K. Dadhia, Issaquah, WA (US); Pradeep Bahl, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/784,060

(22) Filed: Apr. 5, 2007

(51) Int. Cl. G06F 9/455

(52) U.S. Cl. 718/1

(57) ABSTRACT

Virtual machine (VM) management using a group name. By associating VM registration information with a group name, all VMs running off a single physical machine image can be managed (e.g., blocked or unblocked) simultaneously. A service component captures registration information (e.g., IP address-VM name pair) between a virtual machine and a name server. The IP address-VM name pair is recorded (or stored) in the name server database. Based on the VM pair, a record component generates a group name, and stores the VM pair in association with the group name in the name server database. Blocking of the group name then blocks all VMs associated with the group name. Moreover, queries against the group name will then expose all operational VMs for that host. Updates to the group name record can be made based on registration and deregistration of VMs for a given host machine.

### BACKGROUND

Virtual machine (VM) technology is in wide-spread use, and has clear advantages over the traditional methods where multiple operating systems (OS) are hosted on separate physical machines. The benefits of virtual machine-based technology can reduce the overhead of maintaining separate hardware for each OS instance, in scenarios such as testing before deployment, application isolation, and application compatibility, for example. Advantages of VM-based technology include security through isolation among multiple OS instances hosting separate applications, and reduced maintenance overhead for maintaining hardware for the multiple OS instances.

At the network level, VMs are designed to be identified as separate physical machines through unique machine identities (e.g., on the network as well as in a domain), possibly a unique IP address, and unique resource identifiers (e.g., service names for services running on those VMs). Oftentimes, VMs running on a host machine are all booted off the same OS image; thus, if there is a vulnerability (e.g., configuration-related or patch-related) in the image, the vulnerability manifests itself in multiple instances of that image running as a VM. Since each VM has to be maintained as a separate machine at the system-level, the VM has to be scanned for vulnerabilities separately, and updated separately.

Currently, there are no solutions available for identifying VMs as belonging to the same host machine at the network level. For instance, a network-level intrusion prevention system, a network-level firewall, and a network access protection (NAP) system can not identify or track VMs on the same host machine that are running similar software because there is no easy mechanism through which a physical machine can be distinguished from a virtual machine. In a situation, where malware such as a worm is known to be spreading rapidly, conventionally, each VM should be scanned (e.g., via a NAP-based infrastructure or using a network-level scanner) and VM access to the network is blocked. In this situation, where time is of essence, an enterprise administrator will be burdened with addressing each VM, thereby reducing productivity and potentially losing important data.

### SUMMARY

The following presents a simplified summary in order to provide a basic understanding of novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture introduces group-name registration for a physical (or host) machine that runs one or more virtual machines (VMs). Accordingly, VMs belonging to a single host machine can be managed (e.g., blocked or unblocked) simultaneously in a single operation without the need to process (e.g., scan) each VM separately. The group name is registered in a name server (e.g., DNS-domain name server, WINS-Windows™ Internet naming service, Active Directory™) name-registration database.

In operation, a service component (e.g., as part of the host machine or DHCP server) captures registration information (e.g., IP address-VM name pair) between a virtual machine and a name server. The VM pair is recorded (or stored) in the name server database. A record component generates a group name and stores the VM pair in association with the group name in the name server database. The VM pairs for the VMs of the same host machine are then associated with the group name. Queries against the group name will then expose all operational VMs for that host. Updates to the group name record can be made based on registration and deregistration of VMs for given host machine. The group name is unique at the network layer and can be queried by an entity on the network for group-name/IP address mappings, thereby supporting the simultaneous blocking or unblocking of VMs of a host machine.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system for virtual machine management.

FIG. 2 illustrates an alternative system for virtual machine management.

FIG. 3 illustrates an alternative system that employs the service component, record component, and a host DHCP server in a physical machine.

FIG. 4 illustrates yet another alternative implementation where VM management utilizes the external DHCP server and a DNS server.

FIG. 5 illustrates a system where a physical machine employs multiple different OS images with corresponding VMs.

FIG. 6 illustrates a method of managing virtual machines.

FIG. 7 illustrates a method of managing VMs when a fault is detected on a VM.

FIG. 8 illustrates a method of finding group names.

FIG. 9 illustrates a method of group name registration using a DHCP server.

FIG. 10 illustrates a block diagram of a computing system operable to support VM management in accordance with disclosed architecture.

FIG. 11 illustrates a schematic block diagram of an exemplary computing environment for VM management using group names.

### DETAILED DESCRIPTION

The disclosed architecture provides a new way of managing virtual machines (VMs) by associating VMs with a group name in a name server database. This provides more efficient and effective administration of enterprise networks, for example, by facilitating the blocking or unblocking of groups of VMs, rather than individual administration required by conventional architectures. The architecture finds particular application for intrusion protection systems (IPSs), for example, where one VM of a physical machine can become contaminated with malware (e.g., a virus). Where there are multiple VMs running on a single operating system (OS) image, which is a common scenario for VMs, all of the VMs of a physical machine can be blocked simultaneously in a single step until the contamination is cured. Similarly, in the context of software updates, the physical machine as well as the hosted VMs can be blocked from network access until the hosted OS images, for example, are updated to desired software and/or policies.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

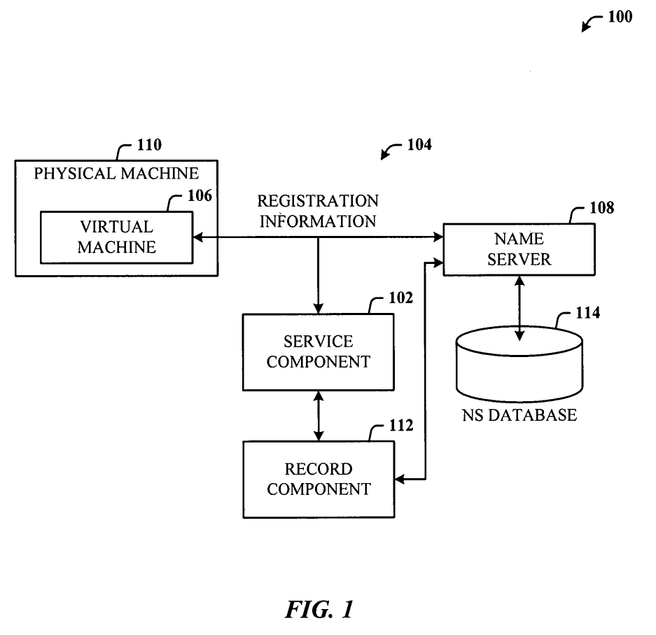

Referring initially to the drawings, FIG. 1 illustrates a computer-implemented system 100 for virtual machine management. The system 100 comprises a service component 102 for capturing registration information 104 (e.g., a VM name and IP address pair) between a virtual machine 106 and a name server 108 during a registration process. The virtual machine 106 can be one of many VMs hosted on a physical (or host) machine 110. The system 100 also includes a record component 112 for generating a group name, and storing (or recording) the registration information in association with the group name in a name server (NS) database 114 (e.g., a DNS (domain name server) database).

In a typical embodiment, the name server 108 includes a NS database 114 that maps the group name to the VM name/IP address pair. More specifically, the database 114 can include records that associate the physical machine name, all VMs running on the physical machine, the group names on the machine, and all VMs in each group. Accordingly, an enterprise administrator, for example, can implement a NAP (network access protection)/NAC (network admission control)-based (or network-vulnerability scanner based) infrastructure where multiple VMs running on the same host machine can be blocked/allowed (or unblocked) simultaneously without the need to scan each VM separately and sequentially. Extensions to DNS and WINS (Windows™ Internet naming service), for example, can make the group-name/IP address mappings available to other entities on the network.

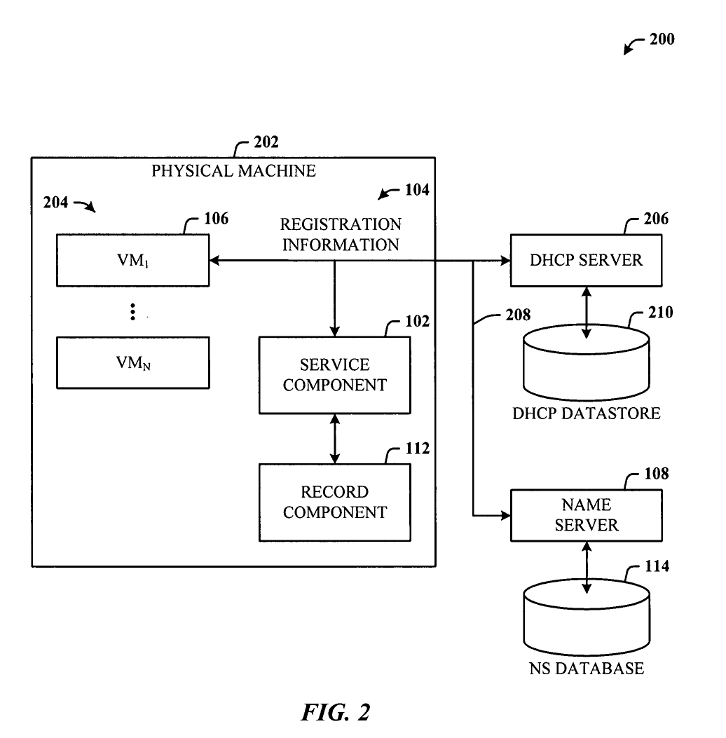

FIG. 2 illustrates an alternative system 200 for virtual machine management. The system 200 includes a physical machine 202 that comprises the service component 102 for capturing the registration information 104 by monitoring interaction between one or more VMs 204 (denoted VM₁, . . . , VM_{N}, where N is a positive integer) and a DHCP server 206. As the VM 106 of the VMs 204 boots, the VM 106 obtains an IP address from the DHCP server 206, where DHCP server 206 is disposed on a network 208. As employed, the DHCP server 206 selects an IP address from a pool of available IP addresses from an associated DHCP datastore 210, and assigns the selected IP address to the VM 106. The VM 106 then maps the IP address to a VM name (of the VM 106) as the registration information 104 that includes a VM name-IP address pair. After obtaining the IP address, the VM 106 registers the VM name-IP mapping (as the registration information 104) with the name server 108 (e.g., DNS or a WINS server) and the associated NS database 114.

Note that other entities on the network 208 (e.g., NAP infrastructure, IPS infrastructure, network scanner, other hosts, other host machine VMs) perceive each VM of the VMs 204 as a separate physical machine having its own IP address. It is to be understood that DHCP may not always be used. In some cases, all or some of the VMs may have static IP addresses assigned. In such a case, the service component 102 may pick up the static IP address from the local machine and register the name-IP pair with the name server database. Similarly, at times, a VM itself may have multiple IP addresses, all static, all DHCP server assigned, or a mix of the two which can all be registered in the name server database 114.

The registration process continues with each of the VMs 204 when booting into the network 208, assigning a different IP address and VM name pair for recording in the name server 108 and associated database 114 in association with the group name. Thus, the physical machine 202 will be associated with the VM-IP address pairs for each of the running VMs 204, in the NS database 114. As an individual VM of the VMs 204 registers or deregisters, the corresponding group record in the NS database 114 will be automatically updated accordingly. Thus, a query for the group name for the physical machine 202 will expose all running VMs 204, thereby allowing the simultaneous handling/blocking of all running VMs 204.

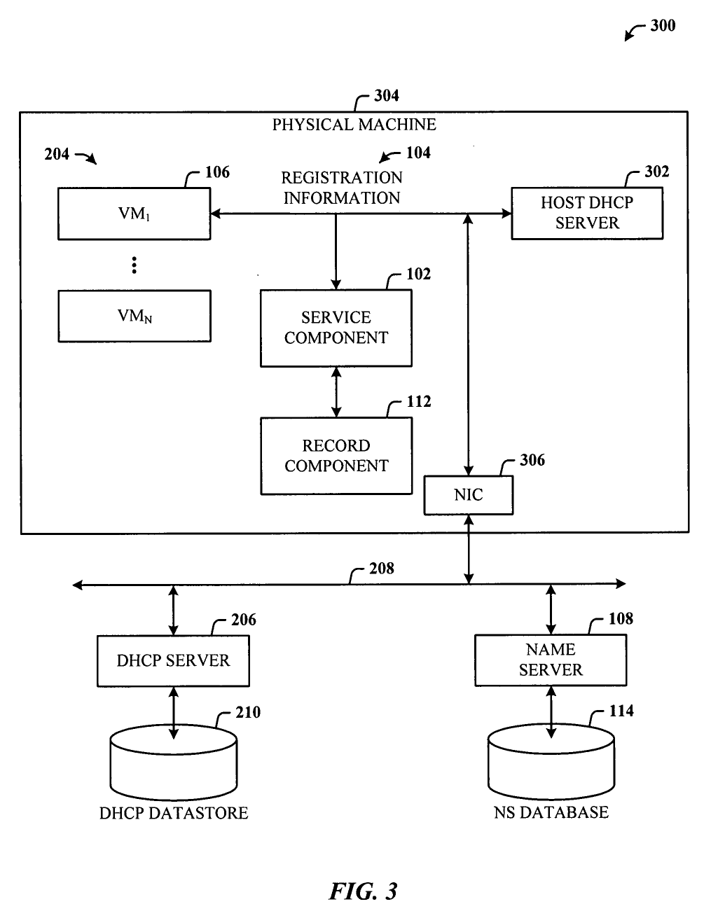

FIG. 3 illustrates an alternative system 300 that employs the service component 102, record component 112, and a host DHCP server 302 internal to a physical machine 304. As illustrated, each of the VMs 204 can obtain an IP address from the host DHCP server 302 running in the host machine 304, where the host machine 304 obtains the host machine IP address from the DHCP server 206 (and database 210) on the network 208. In this embodiment, the IP addresses of the VMs 204 are not visible to entities of the network 208. Essentially, the VMs 204 share a network interface 306 of the host machine 304 (e.g., in a NAT (network address translation)-based configuration).

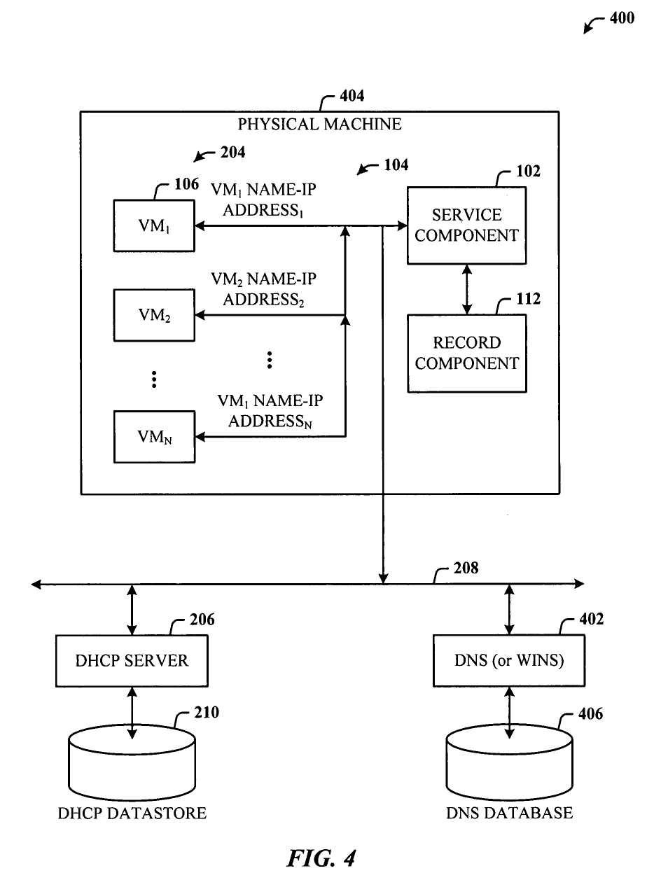

FIG. 4 illustrates yet another alternative implementation 400 where VM management utilizes the external DHCP server 206 and a DNS server 402. Here, a physical machine 404 includes the service component 102 and record component 112 for capturing and recording the registration information 104 in the form of VM name-IP address pairs (denoted VM₁ NAME-IP ADDRESS₁,VM₂ NAME-IP ADDRESS₂, . . . , VM_{N} NAME-IP ADDRESS_{N}).

From the perspective of a VM, the process of obtaining the IP address and registering the VM name-IP mapping with the DNS (or WINS) 402 (and associated DNS database 406) or any other name server remains the same. The VM name/IP Address pair is recorded in the DNS 402 as part of DHCP interaction by either the DHCP server 206 or the VM. The intercepted DHCP interaction between the VMs 204 and the DHCP server 206 is captured by the service component 102 and the relevant VM name's IP address is recorded under a group name by the record component 112 running on the host machine 404.

More specifically, the host machine 404 creates another A-record (a DNS record) on the DNS server 402 with a virtual host name “HostName-GroupName-VM”, where HostName is the host name of the host machine 404, and “-GroupName-VM” is a string identifying a group of VMs on the host. The IP address of a VM is added to this record, as DHCP/DNS registration information for other VMs 204 is learned by the service component 102. The relevant A-records for different groups of VMs, all VMs typically running the same OS image, are updated accordingly. An A-record (or address record) maps a name to one or more 32-bit IPv4 addresses. Alternatively, an AAAA record (or IPv6 address record) can be employed that maps a name to one or more 128-bit IPv6 addresses.

As the IP addresses are released (for deregistration) by the VMs 204 at the time of shutdown or other events, the service component 102 captures these interactions, and the record component 112 running on the host machine 404 updates the A-records (or AAAA records) of the group names to which the VMs belong, accordingly.

For the purpose of discovery, the host machine 404 can also create a DNS SRV (service location locator) resource record for the group name so that an entity on the network 208 can learn about all of the registered group names corresponding to a hostname. An SRV record is a category of data in the DNS system that specifies information on available services on a host machine. In addition to the above SRV record mapping a host name to the various groups of VMs running on it, the host machine 404 can also create a DNS SRV record mapping for a group name to all its VM names. This allows easy determination of all VM names belonging to a group on a physical machine

Other entities on the network 208 can query the A-record (or AAAA record), learn of all VMs 204 running on the single host machine 404, and take collective decisions for the VMs 204, in a single step. Thus, where the VMs 204 boot off the same OS image, the VMs belonging to the same group can be collectively blocked as soon as a single vulnerable or infected IP address is discovered.

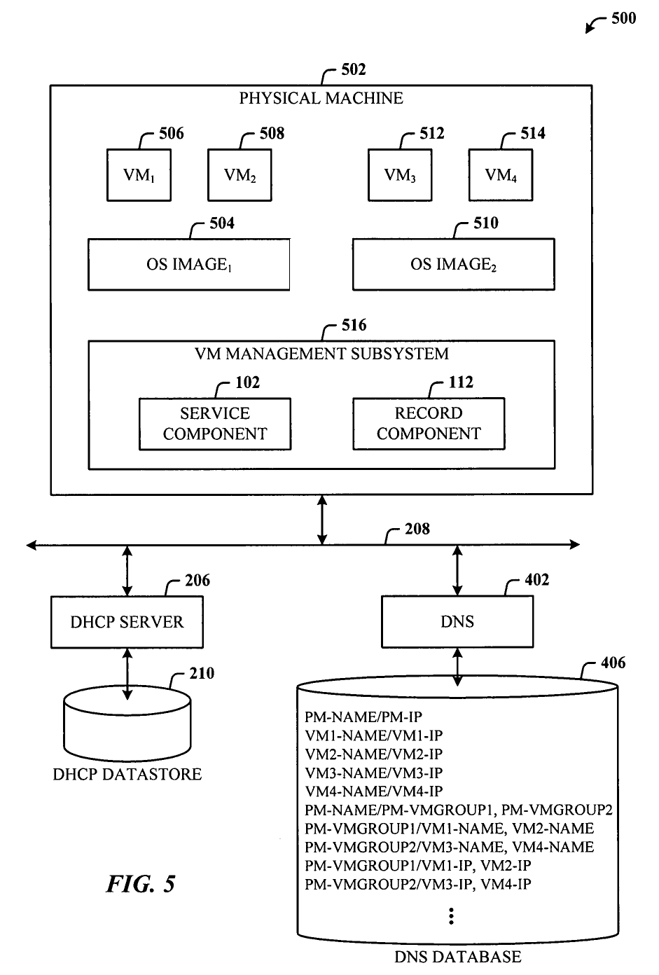

FIG. 5 illustrates a system 500 where a physical machine 502 employs multiple different OS images with corresponding VMs. The physical machine 502 includes a first OS image 504 from which a first VM 506 and a second VM 508 launch and, a second and different OS image 510 from which a third VM 512 and a fourth VM 514 launch. The physical machine 502 also includes a VM management subsystem 516 that includes the service component 102 and the record component 112 for capturing registration information for each of the VMs (506, 508, 512 and 514) when coming online. When registration is completed by the physical machine 502, the DNS database 406 will include one or more related records for managing some or all of the VMs (506, 508, 512 and 514) simultaneously.

In most situations, group-name mapping would be performed on a per image basis, thereby allowing selective blocking of VMs according to the OS image. In this embodiment, the records in the DNS database 406 can include the physical machine (PM) mappings to one or more IP addresses (PM-NAME/PM-IP) of the physical machine hosting the VMs and entries for each of the VM/IP address mappings (VM1-NAME/VM1-IP, VM2-NAME/VM2-IP, VM3-NAME/VM3-IP and VM4-NAME/VM4-IP). These records can then be related to the PM via a SRV record that maps PM-NAME to PM-VMGROUP1 and PM-VMGROUP2, and other SRV records that map PM-VMGROUP1 to VM1-NAME and VM2-NAME, and PM-VMGROUP2 to VM3-NAME and VM4-NAME. Additionally, A or AAAA records can map PM-VMGROUP1 to VM1-IP and VM2-IP, and PM-VMGROUP2 to VM3-IP and VM4-IP.

In an alternate embodiment, VMs running different OS images can be part of the same group. In this scenario, the records in the DNS database 406 include the PM mapping to an IP address (PM-NAME/PM-IP), and entries for each of the VM/IP address mappings (VM1-NAME/VM1-IP, VM2-NAME/VM2-IP, VM3-NAME/VM3-IP and VM4-NAME/VM4-IP). These records are then related to the PM via a SRV entry that maps PM-NAME to PM-VMGROUP and another SRV record that maps PM-VMGROUP to V1-NAME, V2-NAME, V3-NAME, and V4-NAME, or alternatively/additionally an A or AAAA record that maps PM-VMGROUP to VM1-IP, VM2-IP, VM3-IP, and VM4-IP. This type of mapping can occur where the underlying OS images (504 and 510) have some measure of similarity such that, for example, malware can corrupt both OS (OS1 and OS2). Here, all VMs (506, 508, 512 and 514) can be blocked simultaneously.

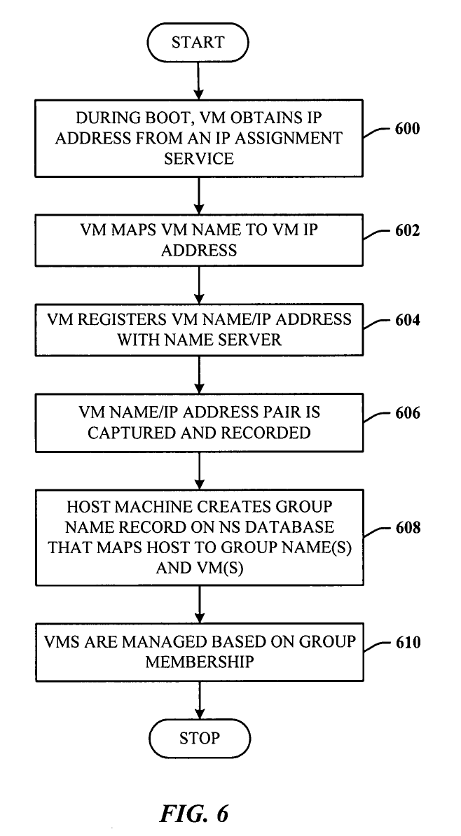

FIG. 6 illustrates a method of managing virtual machines. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

At 600, during a boot operation on the host machine, the VM obtains an IP address from an IP assignment service (e.g., a DHCP server) or it has one or more static IP address(es) or a mix of DHCP assigned and static IP addresses, At 602, the VM maps a VM name to the IP address. At 604, the VM registers the VM name/AP address pair with a name server (e.g., a DNS). At 606, the VM name/IP address pair are captured and recorded. At 608, the host machine creates group name records (e.g., SRV) on the name server (database), which map the host to the VM group names and the VMs. At 610, the VMs are managed based on the group membership. A or AAAA-records are created for each group to map the VM group to the VM IP addresses. Alternatively or additionally, an SRV record can be created to map a VM group name to VM names. A or AAAA records mapping IP address(es) to VM names get created as part of normal name registration by the machine and/or the DHCP server. This includes searching the group name to obtain all VMs associated therewith on the assign host machine.

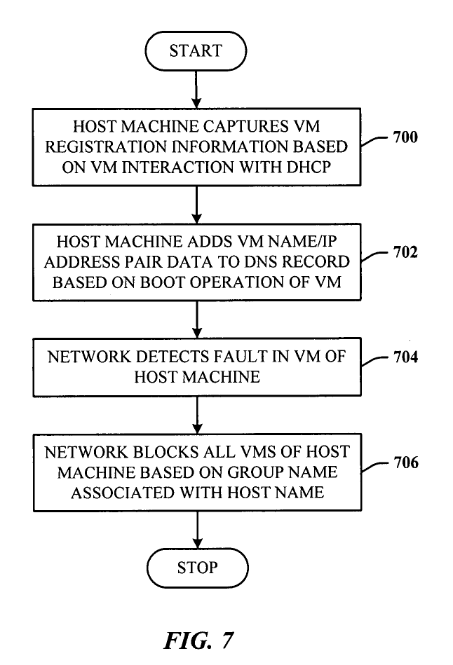

FIG. 7 illustrates a method of managing VMs when a fault is detected on a VM. At 700, a host machine captures VM registration information based on VM interaction with a DHCP server. At 702, the host machine adds the VM name/IP address pair data to a DNS record based on a boot operation of the VM. At 704, the network (or network entity) detects a fault on a VM of the host machine. At 706, the network blocks all VMs of the host from the network based on the group name in the DNS, the group name associated with the VMs of the host machine.

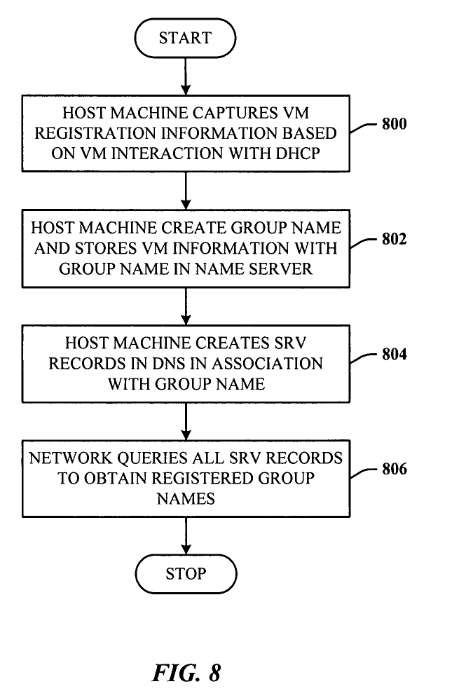

FIG. 8 illustrates a method of finding group names. At 800, a host machine captures VM registration information (e.g., VM name and IP address pair) based on VM interaction with DHCP server. At 802, the host machine creates a group name and stores registration information with the group name in a name server. At 804, the host machine creates SRV records in the DNS in association with group names. At 806, the network (or network entity) searches the SRV records of the name server to obtain registered group names.

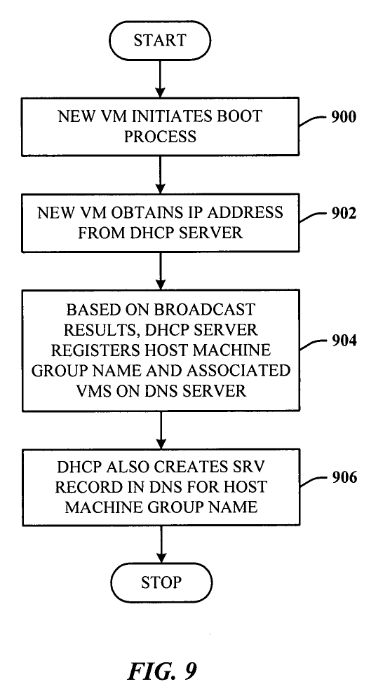

FIG. 9 illustrates a method of group name registration using a DHCP server. It is to be understood that this method can also apply to a WINS server, for example, or other types of IP address assignment servers. At 900, a new VM initiates a boot process in the host machine. At 902, the new VM obtains an IP address from the DHCP server. At 904, the DHCP server registers the host machine group name and associated VMs on the DNS server. At 906, the DHCP also creates SRV records in the DNS for the host machines group name. Thereafter, the SRV records can be searched for all group names.

A DHCP broadcast can be used to obtain an IP address. The VM name is sent in the broadcast request to the DHCP server. The DHCP server assigns an address and after the address has been committed for the machine (e.g., after a couple of more round trips between the machine and the DHCP server), the DHCP server registers the appropriate records in the DNS. Alternatively, the records can be registered by the machine as described earlier or some of the records can be registered by the machine (e.g., pointer (PTR) record mapping of an IP address (IPv4 or IPv6) to a name) and the A-record (as well as SRV records) by the DHCP server. The PTR record does the reverse mapping in DNS by mapping the IP address to the name.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

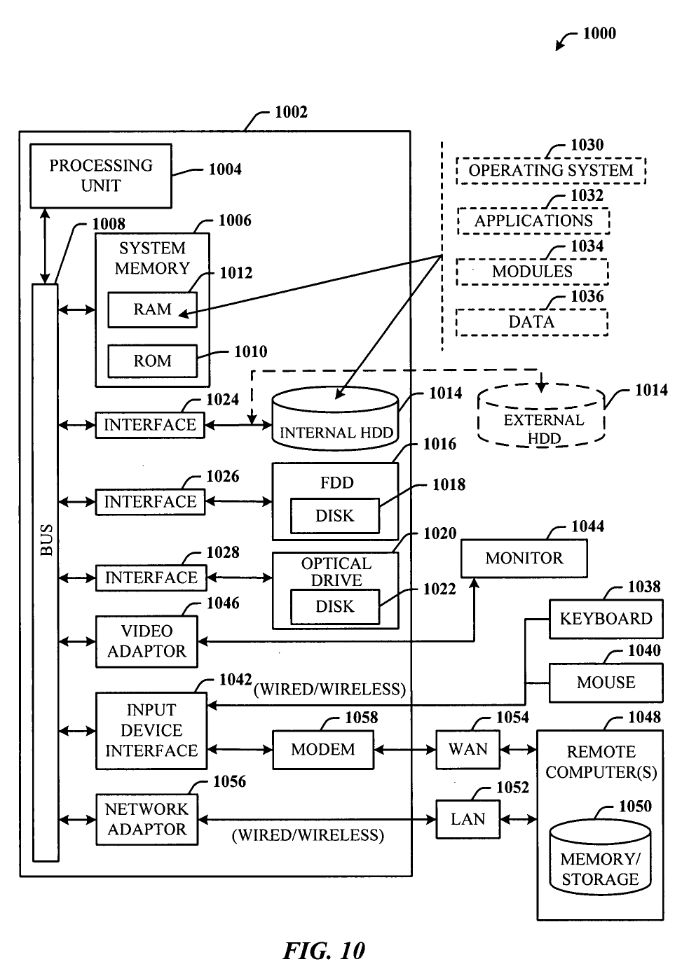

Referring now to FIG. 10, there is illustrated a block diagram of a computing system 1000 operable to support VM management in accordance with disclosed architecture. In order to provide additional context for various aspects thereof, FIG. 10 and the following discussion are intended to provide a brief, general description of a suitable computing system 1000 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 10, the exemplary computing system 1000 for implementing various aspects includes a computer 1002, the computer 1002 including a processing unit 1004, a system memory 1006 and a system bus 1008. The system bus 1008 provides an interface for system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is to be appreciated that the disclosed architecture can be implemented with various commercially available operating systems or combinations of operating systems.

The applications 1032 and/or modules 1034 can include the service component 102 and record component 112, and the internalized DHCP server 302, for example. Additionally, the VM OS's can launch separate instances of the operation system 1030. The internal HDD 1014 can server as storage for the VM images, as can the external HDD 1014.

A user can enter commands and information into the computer 1002 through one or more wired/wireless input devices, for example, a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, for example, computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3 or Ethernet).

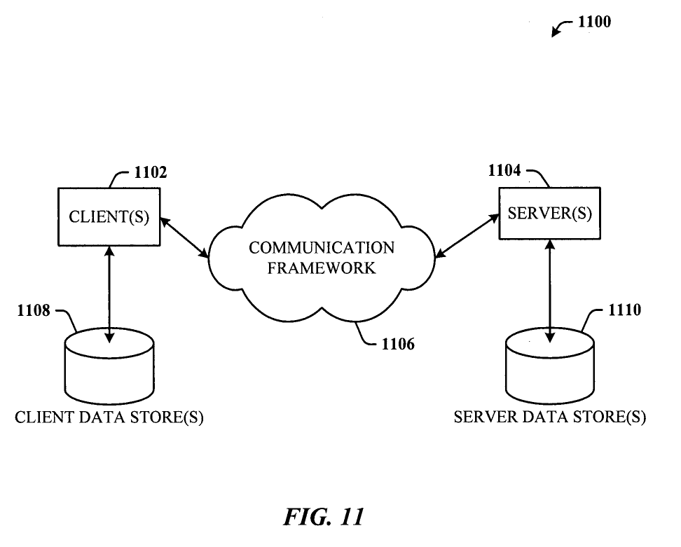

Referring now to FIG. 11, there is illustrated a schematic block diagram of an exemplary computing environment 1100 for VM management using group names. The system 1100 includes one or more client(s) 1102. The client(s) 1102 can be hardware and/or software (e.g., threads, processes, computing devices). The client(s) 1102 can house cookie(s) and/or associated contextual information, for example.

The system 1100 also includes one or more server(s) 1104. The server(s) 1104 can also be hardware and/or software (e.g., threads, processes, computing devices). The servers 1104 can house threads to perform transformations by employing the architecture, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104. The servers 1104 can include the name server 108, DHCP server 206, DHCP server 302, and/or DNS (or WINS) server 402, for example.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system for virtual machine management, comprising:
a service component for capturing registration information between a first virtual machine and a name server, the first virtual machine hosted on a physical machine; and
a record component for generating a group name, and storing the registration information in association with the group name.

2. The system of claim 1, wherein the service component executes on the address server or the physical machine.

3. The system of claim 2, wherein the address server is a dynamic host configuration protocol (DHCP) server.

4. The system of claim 1, wherein the registration information captured by the service component is for registering the first virtual machine to the name server.

5. The system of claim 1, wherein the registration information captured by the service component is for deregistering the first virtual machine from the name server.

6. The system of claim 1, wherein the first virtual machine executes according to a first operating system and a second virtual machine of the physical machine executes according to a same or different operating system, the record component generates the group name in association with both the first virtual machine and the second virtual machine.

7. The system of claim 1, wherein the first virtual machine executes according to a first operating system and a second virtual machine of the physical machine executes according to a second operating system, the record component generates the group name in association with the first virtual machine and a second group name in association with the second virtual machine.

8. The system of claim 1, wherein the address server is a DHCP server that registers the group name with a domain name server (DNS).

9. The system of claim 1, wherein the registration information includes a virtual machine name mapped to an IP address, and a host machine name mapped to the group name in a DNS.

10. A computer-implemented method of managing virtual machines, comprising:
intercepting name-address information of virtual machines of a host machine;
generating a network-level group name for the host machine;
storing the group name on a name service;
associating the host machine and the virtual machines with the group name; and
managing the virtual machines based on the group name.

11. The method of claim 10, further comprising storing a host machine identifier and corresponding identifiers for the virtual machines in association with the group name.

12. The method of claim 11, further comprising automatically updating the identifiers of the virtual machines associated with the stored group name based on a change in status of one of the virtual machines.

13. The method of claim 10, further comprising querying the group name based on a group-name/IP mapping.

14. The method of claim 10, further comprising blocking one or more of the virtual machines based on the group name.

15. The method of claim 10, further comprising generating a service locator resource record on the name server that includes VM group names for the host name and optionally VM names for a VM group name.

16. The method of claim 15, further comprising querying the service locator resource record to learn of registered VM group names and VM names.

17. The method of claim 10, further comprising generating an address record on the name server that maps the group name to one or more IPv4 or IPv6 addresses.

18. The method of claim 17, further comprising searching the address record to determine the virtual machines associated with the host machine.

19. The method of claim 10, further comprising blocking one or more of the virtual machines based on a common operating system image.

20. A computer-implemented system, comprising:
computer-implemented means for intercepting name-address information of virtual machines on a host machine;
computer-implemented means for generating a network-level group name for the host machine;
computer-implemented means for registering the group name with a name service; and
computer-implemented means for associating the host machine and the virtual machines with the group name.
